(19) United States
(12) Patent Application Publication
(10) Pub. No.: US 2009/0242841 A1
(43) Pub. Date: Oct. 1, 2009

(54) Combustion Air Preheat Optimization System In An SMR

(75) Inventors: Frederic Judas, Houston, TX (US); Michael Wakim, Houston, TX (US)

Correspondence Address: AIR LIQUIDE;Intellectual Property, 2700 POST OAK BOULEVARD, SUITE 1800, HOUSTON, TX, 77056, US

(73) Assignee: AIR LIQUIDE PROCESS AND CONSTRUCTION Inc., Houston, TX (US)

(21) Appl. No.: 12/410,624

(22) Filed: Mar. 25, 2009

Related U.S. Application Data
(60) Provisional application No. 61/039,468, filed on Mar. 26, 2008.

(51) Int. Cl. C01B 3/06

(52) U.S. Cl. 252/373

(57) ABSTRACT

A process for producing synthesis gas from a furnace, the furnace including a combustion air stream, a convective section and a reformer flue gas stream is presented. The furnace may additionally include a process cooling section and one or several boiler feed water stream. This process includes passing the combustion air stream through a preheat exchanger system in the convective section to preheat the combustion air stream in indirect heat exchange with the reformer flue gas, wherein the temperature of the preheated combustion air is between about 200° F. and about 400° F. The temperature of the preheated combustion air may be between about 225° F. and about 350° F. The temperature of the preheated combustion air may be between about 250° F. and about 325° F. The process may further include passing the boiler feed water stream through heating coils in the process cooling section and the convective section.

### CROSS-REFERENCE TO RELATED APPLICATIONS

This application claims the benefit of U.S. Provisional Application No. 61/039,468, filed Mar. 26, 2008, the entire contents of which are incorporated herein by reference.

### FIELD OF THE INVENTION

This invention relates to method for optimizing the operation of a Steam Methane Reformer (SMR) by controlling the combustion air preheat (CAP) temperature.

### BACKGROUND

As the SMR is a consumer of steam, and the process itself produces hot gas streams well suited to produce steam, an SMR will typically always have an integral heat recovery steam generator. Most SMR installations are net exporters of steam, which they supply to the host site, typically to improve the overall economics of the process.

One option that the process engineer that is designing the SMR system has available is the utilization of CAP. Should the host site require less steam than the natural net output of the SMR, the designer may equip the SMR with one or two stages of CAP. The combustion air is preheated against the flue gas coming out of the reformer. This option thus decreases the heat available in the convection section for steam production.

When no steam restriction applies, and the host is willing to accept all the steam that the SMR naturally produces, the SMR is designed with no CAP. This presents the advantage of maximizing the steam export, decreasing the capital cost of the plant and increasing the sales revenues from the plant. On the other hand, this solution shows an increased fuel consumption as well as an increased emission of CO₂ or NOₓ suggesting room for improvement.

### SUMMARY

The present invention is a process for producing synthesis gas from a furnace, the furnace includes a combustion air stream, a radiant section where the reaction occurs, a convective section and a reformer flue gas stream. The furnace may additionally include a cooling train for the process gas and one or several boiler feed water streams. This process includes passing the combustion air stream through a preheat exchanger in the convective section to preheat the combustion air stream in indirect heat exchange with the reformer flue gas, wherein the temperature of the preheated combustion air is between about 200° F. and about 400° F. The temperature of the preheated combustion air may be between about 225° F. and about 350° F. The temperature of the preheated combustion air may be between about 250° F. and about 325° F. The process may further include passing the boiler feed water stream through heating coils in the process cooling section and the convective section.

### DESCRIPTION OF PREFERRED EMBODIMENTS

The invention may be understood by reference to the following description taken in conjunction with the accompanying drawings, and in which:

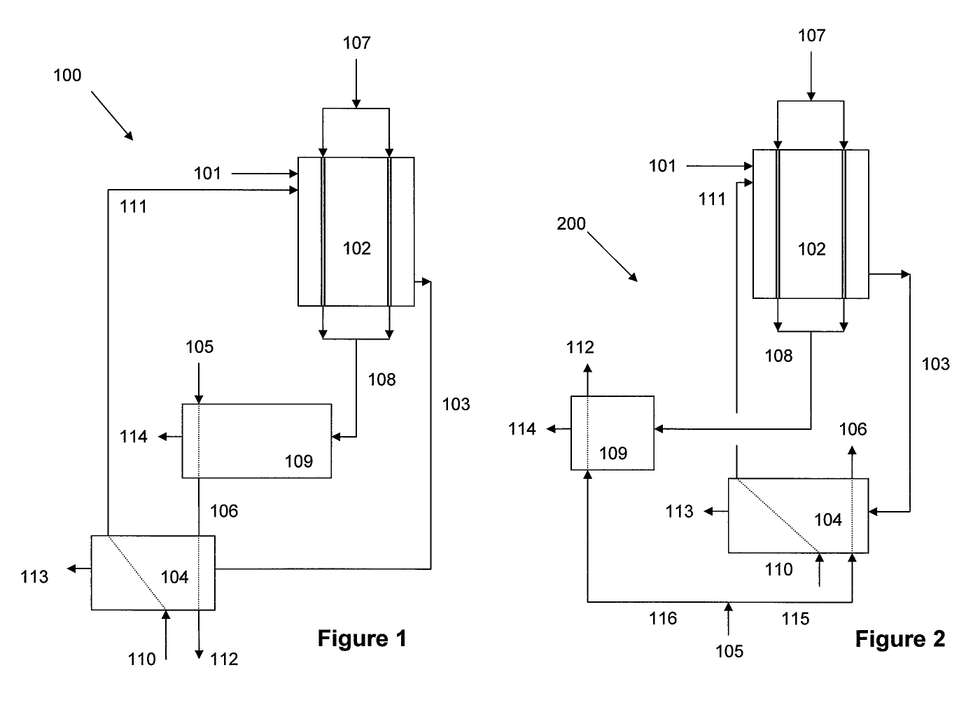

FIG. 1 is a schematic representation of one embodiment of the present invention, with the boiler feed water heating being performed serially.

FIG. 2 is a schematic representation of another embodiment of the present invention, with the boiler feed water heating being performed in parallel.

### DESCRIPTION OF PREFERRED EMBODIMENTS

The present invention relates to a method of optimization of a Steam Methane Reformer (SMR) plant by defining the CAP temperature in such a way as to produce hydrogen and steam under the best available conditions when there is no constraint on the steam production. SMRs are used to produce hydrogen from methane and steam. This reaction occurs at high pressure and temperature, thereby releasing a considerable quantity of heat. A portion of this heat may be used to produce export steam as a by-product. Depending of the location where the SMR is to be installed, the host site may not be willing or able to accept all the steam that is naturally produced by the SMR.

The present invention provides a range of CAP temperature that increases the efficiency of a SMR by purposely reducing the steam export even when no restriction applies on the steam production.

By voluntarily designing one stage of CAP, and by setting the temperature of the air to the reformer in the about 200° F. to about 400° F. range, the design of the steam methane reformer achieves a maximum efficiency. Setting the CAP temperature in this range when nothing else is constraining the design, allows the designer to minimize the specific energy required for the production of hydrogen. Furthermore the invention allows for a better integration into the host facility and for more synergies with the host by optimizing the steam balance.

More precisely, the most efficient SMR is designed, when the steam system allows the preheating of the boiler feed water in the process cooling train as well as in the convection section, and for a CAP temperature between about 200 F and about 400 F. This scheme allows for the maximum heat recovery from the SMR and the maximum net efficiency toward the hydrogen production even if this does not maximize the amount of steam produced.

In another embodiment, the CAP temperature may be between 225 F and 350 F. In another embodiment, the CAP temperature may be between about 250 F and about 325 F. Note the present invention is applicable to systems comprising a single steam system, a single steam system with a condensate stripper, or a multiple steam system. Note that the present invention is applicable to systems utilizing oxygen-enriched air for combustion air. In this application, the term “oxygen-enriched air” means air with an oxygen content that is greater than about 21%.

Turning now to FIG. 1, an optimized steam system 100 is provided. Fuel stream 101 is introduced into SMR 102, thereby providing heat and temperature for the reforming process, and producing reformer flue gas stream 103. Reformer flue gas stream 103 is introduced into convective 104, where it indirectly exchanges heat with heated boiler feed water stream 106, thereby producing further heated boiler feed water stream 112, and where it indirectly exchanges heat with combustion air stream 110, thereby producing preheated combustion air stream 111. Preheated combustion air stream 111 is then introduced into SMR 102. Preheated combustion air stream 111 may have CAP temperature of between about 200 F and about 400 F, preferably between 225 F and 350 F, even more preferably between about 250 F and about 325 F. The flue gas stream exits as exhaust stream 113.

Blended hydrocarbon and steam stream 107 is introduced into the catalyst tubes of SMR 102, which react to produce hot syngas stream 108. Hot syngas stream 108 is introduced into process cooling section 109. Within the process cooling section 109, hot syngas stream 108 also indirectly exchanges heat with cold boiler feed water stream 105, thereby producing heated boiler feed water stream stream 106, and with the syngas stream exiting as syngas product stream 114.

Turning now to FIG. 2, an optimized steam system 200 is provided. In the interest of clarity, the stream and element numbers for FIG. 1 have been maintained in FIG. 2. Boiler feed water stream 105 is split into two portions, convective section feed stream 115 and process cooling section feed stream 116. Reformer flue gas stream 103 is introduced into convective 104, where it indirectly exchanges heat with convective section feed stream 115, thereby producing heated boiler feed water stream 106. Within process cooling section 109, process cooling section feed stream 116 indirectly exchanges heat with hot syngas stream 108, thereby producing heated boiler feed water stream 112.

It should be noted that one skilled in the art would recognize that alternative embodiments are also possible

What is claimed is:

1. A steam reforming process for producing synthesis gas from a furnace comprising a combustion air stream, a convective section, and a reformer flue gas stream, comprising:
passing the combustion air stream through a preheat exchanger system in the convective section to preheat the combustion air stream in indirect heat exchange with the reformer flue gas, wherein the temperature of the preheated combustion air is between about 200° F. and about 400° F.

2. The steam reforming process of claim 1, wherein the temperature of the preheated combustion air is between about 225° F. and about 350° F.

3. The steam reforming process of claim 1, wherein the temperature of the preheated combustion air is between about 250° F. and about 325° F.

4. The steam reforming process of claim 1, wherein the preheat system is composed of at least one preheat coil.

5. The reforming process of claim 1, wherein the combustion air stream comprises oxygen-enriched air.

6. The steam reforming process of claim 1, the furnace further comprising a process cooling section and a boiler feed water stream, the process further comprising:
passing the boiler feed water stream through the process cooling section and through the convective section.

7. The steam reforming process of claim 6, wherein the boiler feed water is preheated in first through the cooling section and then through the convective section.

8. The steam reforming process of claim 6, wherein the boiler feed water is preheated in the cooling section and the convective section in parallel.
